(19) United States
(12) Patent Application Publication
(10) Pub. No.: US 2014/0299217 A1
(43) Pub. Date: Oct. 9, 2014

(54) PIPE REPAIR METHOD AND REPAIRED PIPE

(71) Applicant: Mark Grundmann, Arvada, CO (US)

(72) Inventor: Mark Grundmann, Arvada, CO (US)

(73) Assignee: CONSTRUCTION RESEARCH & TECHNOLOGY GMBH, Trostberg (DE)

(21) Appl. No.: 13/994,603

(22) PCT Filed: Dec. 19, 2011
(86) PCT No.: PCT/EP2011/073203

§ 371 Date: Aug. 22, 2013

Related U.S. Application Data
(60) Provisional application No. 61/425,076, filed on Dec. 20, 2010.

(51) Int. Cl. F16L 55/18

(52) U.S. Cl. CPC F16L 55/18
USPC 138/98

(57) ABSTRACT

An in situ method of repairing an underground conduit or pipe is disclosed. The method of repairing includes positioning a reinforcing fabric within the pipe being repaired, spaced apart from the inner surfaces of the pipe, and infiltrating the fabric with a bleed resistant cementitious composition.

### CROSS REFERENCE TO RELATED APPLICATIONS

This application claims the benefit of the filing date of U.S. Provisional Application Ser. No. 61/425,076 filed Dec. 20, 2010, which is hereby incorporated by reference.

### TECHNICAL FIELD

This disclosure relates to a method for repairing a pipe having a structural defect.

### BACKGROUND

Pipelines, such as sewer, gas, steam and water pipes made of ductile iron, concrete, asbestos concrete, clay tile and other pipe constructions, are often found underground or in inaccessible areas. Due to mechanical harm, premature wear, manufacturing defects, corrosion, erosion, adverse operating conditions, and other factors, these pipes deteriorate, developing cracks, leaks, or weakened areas requiring replacement or rehabilitation. It is extremely expensive to excavate and externally repair or replace a segment of an inaccessible or underground pipe.

Current methods for relining small diameter pipes less than 16 inches in diameter rely on resin-impregnated fabric which is held against the interior wall of the pipe until the resin cores sufficiently to form a structural bond, slip-lining existing pipes with plastic extrusions, and/or use of non-reinforced cementitious composition in conjunction with a plastic liner. Pressure-expandable techniques and inversion techniques are used to closely conform the lining to the inner surface of the pipe being repaired.

Slip lining involves placing, a liner pipe of plastic material, such as smooth wall polyethylene or composites of polyethylene and polypropylene, inside an existing of host pipe, which reduces the interior diameter of the host pipe. After the plastic material pipe has been placed inside the host pipe. the annulus between the liner pipe and host pipe is filled with a cementitious material.

In a “pressure-expandable” technique (also called the “winch-in-place” technique), a pliable sleeve of material which has been previously impregnated with a thermosetting resin is inserted into a damaged pipe portion and pressurized so that the resin-impregnated liner presses firmly against the inner wall of the damaged pipe. The expanded liner is then permitted to cure to form a new lining within the original pipe.

In the “inversion” repair method, the pipe liner is First impregnated with a suitable curable synthetic resin. The resin-filled liner is next inserted into a pipe. The leading end of the liner is turned back onto itself and fixed to the lower end of a feed elbow of a manhole. A fluid, such as water or air, is pumped into the feed elbow which causes the liner to invert into and along the inner surfaces of the pipe. The liner is maintained in engagement with the inner surfaces of the pipe until the resin cures. After the resin cure has been completed, the fluid is drained from the inside of the liner, thus leaving a hard, rigid lining applied to the pipe's inner surface.

These solutions do not solve the underlying need for a composite that is mechanically and chemically bonded to the inner diameter of a host pipe, has sufficient tensile, axial, compressive, and hoop strength development to stand alone as a new pipe within a pipe to which existing lateral services could be attached, is substantially water-tight along its length, strong, light-weight, and relatively quick and easy-to-install, to provide a stand alone fix for sanitary, steam and drinking water pipe applications.

### DESCRIPTION

Disclosed is an in situ method for repairing a pipe having a structural defect. The method for repairing the pipe method re-establishes the structural integrity of deteriorated pipes without having to take the pipe out of service.

According to certain illustrative embodiments, the method comprises positioning a reinforcing fabric within at least a portion of the host pipe being repaired and at least partially infiltrating the reinforcing fabric with a bleed resistant cementitious composition. The cementitious composition is permitted to harden. Once the cementitious composition hardens, a new composite pipe is established adjacent the inner surface at least a portion of the length of the host pipe.

According to other illustrative embodiments, the method comprises positioning a spacer layer or sleeve within at least a portion of the host pipe being repaired. The spacer layer is positioned adjacent the inner surface of the host pipe in a spaced-apart relationship forming an annular cavity between the inner surface of the host pipe and the outer surface of the support layer or sleeve. A reinforcing fabric, such as a bi-directional woven fabric, is positioned adjacent the spacer layer such that the spacer layer is located between the inner surfaces of the host pipe being repaired and the outer surface of the reinforcing fabric layer. The reinforcing fabric is at least partially infiltrated and the annular cavity is at least partially filled with a hardenable cementitious composition. The cementitious composition is permitted to harden. Once the cementitious composition hardens, a new composite pipe is established adjacent at least a portion of the inner surface of the host pipe.

The method of repairing a pipe having a structural defect may comprise positioning a flexible, tubular support sleeve of polymeric material within at least a portion of the interior of the pipe to be repaired, spaced apart from an inner surface of the pipe, the sleeve having an inner surface and an outer surface, the outer surface of the sleeve having spacing elements comprising a plurality of projections projecting axially and radially from the outer surface of the sleeve. Because of the external diameter and radial projections of the support sleeve, an annular cavity is formed between the host pipe and the outer surface of the support sleeve. A reinforcing fabric layer, which may be provided in the form of a tubular fabric reinforcing layer of fibrous material, is positioned in contact with the inner surface of the support sleeve within the host pipe. According to certain embodiments the reinforcing layer of fibrous material is physically or chemically bonded to the support sleeve; However, according to alternative embodiments, the reinforcing layer of fibrous material is provided with a tensile strength sufficient to provide a self-standing reinforcing fibrous layer that is positioned adjacent at least a portion the support sleeve. An extendable expander may be positioned inside of the reinforcing layer and is extended to push the reinforcing layer and support sleeve radially outwardly towards the inner surface of the host pipe. A hardenable cementitious composition is introduced into reinforcing fabric and into the annular cavity between the support sleeve and the inner surface of the host pipe and the cementitious composition is permitted to harden.

According to certain embodiments where the reinforcement layer is physically or chemically bonded to the support sleeve, localized deformation within the support sleeve is reduced. With reduced localized deformation in the sleeve, failure of the repair pipe is less likely to occur and the duration of use is extended.

Without limitation, the hardenable cementitious composition may be introduced in the annular cavity between the support sleeve and the inner surface of the pipe at a first point along the length of the pipe so as to fill the annular cavity by flowing the cementitious composition in a generally longitudinal direction through the host pipe away from the first point towards a second point along the pipe. The spacing elements projecting away from the outer surface of the support sleeve penetrate the cementitious composition as it flows in the annular cavity forming a mechanical bond with the cementitious composition when the cementitious composition hardens. The cementitious composition is permitted to harden to form a composite of the reinforcing layer, the support sleeve, and the cementitious composition, the composite forming a pipe within a pipe, the spacing elements being embedded in the cementitious composition upon hardening of the cementitious composition.

The method further comprises terminating the introduction of the cementitious composition into the annular cavity and causing or permitting the cementitious composition to set or solidify in the annular cavity between the pipe and the support sleeve, the cementitious composition forming a bond with the support sleeve and the reinforcing layer. The cementitious grout material may penetrate and infiltrate the reinforcing fibrous fabric layer to form a stand-alone composite material. According to other embodiments, the cementitious grout material may penetrate both the reinforcing fabric material and at least partially the support sleeve material to bond the composite of reinforcing fabric and grout to the support sleeve. If the composite is used as a stand alone, then the grout would essentially form the new interior of the pipe. This would be desirable for high temperature applications like steam/condensate pipes or anywhere the various plastic composites would be susceptible to attack from interior conditions or components. The expander is maintained in an extended position until the cementitious composition sets sufficiently to be self-supporting. Thereafter, the expander is retracted.

The cementitious composition and the support sleeve are capable of elastic deformation until the cementitious composition sets. Localized elastic deformation facilitates the continued introduction of new cementitious composition within the annular space. As the cementitious composition and sleeve are subjected to varying forces created by the addition of more cementitious composition, localized elastic deformation prevents premature cracking and failure of the composite during installation.

According to certain embodiments, the expander is mounted on a mandrel, and the support sleeve is positioned within the pipe being repaired by wrapping the support sleeve around the mandrel and expander, and inserting the mandrel and expander into the pipe with the spacing elements projecting from the outer surface of the support sleeve facing the inner surface of the host pipe, and moving it to the location to be repaired.

According to certain embodiments, the expander is mounted on a mandrel, and the fabric reinforcing layer is positioned within the pipe being repaired by wrapping the reinforcing layer around the mandrel and expander, inserting the mandrel and expander into the support sleeve inside the pipe, and moving it to the location to be repaired.

According to certain embodiments, the expander comprises an inflatable bladder and the expander is extended by inflating the bladder with a pressurized fluid. The pressurized fluid may be a gas, a liquid or a combination of a gas and a liquid.

Also provided is a method of lining a host pipe having an inner and an outer surface. The method comprises applying a support sleeve of a polymeric material within at least a segment of a pipe to be repaired. The support sleeve is positioned within the pipe being repaired in a spaced apart relationship from an inner surface of the pipe.

The support sleeve may include a plurality of projections projecting axially and radially from the outer surface of the support sleeve to provide such a spaced-apart positioning between the host pipe and the support sleeve. A reinforcing layer of fibrous material is applied adjacent the inner surface of the support sleeve located in the host pipe. A flowable cementitious material, such as a grout composition that is resistant to bleeding, is introduced into openings of the reinforcing fabric and inside the space between the support sleeve and the inner surface of the host pipe. The cementitious composition is caused or allowed to harden to form a mechanical bond between the projections of the support sleeve and the inner surfaces of the host pipe, and between the composition and the support sleeve and reinforcing layer.

Also provided is a repair liner for lining a host pipe. The repair liner for the host pipe comprises a reinforcing layer of fibrous material and a support sleeve of flexible polymeric material that include elements for spacing the liner apart from an inner surface of the host pipe. The support sleeve includes an inner and an outer surface, where the inner surface of the support sleeve contacts the reinforcing layer of fibrous material. The outer surface of the support sleeve includes spacing elements that project axially and radially from the outer surface of the support sleeve. The spacing elements are positioned on the support sleeve such that a flowable, hardenable cementitious composition can flow between these elements so as to create a mechanical bond between the liner and the host pipe.

Also provided is a repaired pipe. The repaired pipe comprises a host pipe having an inner surface and a length and a cured composite material adjacent said inner surface of said host pipe. The composite material comprises a reinforcing fabric at least partially infiltrated with a bleed resistant cementitious composition. The hardened cementitious composition is in contact with the structural fabric and forms a hardened lining against the interior surface of the host pipe.

The present method is broadly applicable to pipes of any diameter. According to certain embodiments, the present method may be applicable to repairing small diameter pipes of less than 16″ in diameter. The method has application to all known pipe materials, including concrete, plastic, iron, and steel. The term “pipe” includes conduits, pipes, tunnels, culverts and enclosed containers, pump stations and wet wells and the like. The method is applicable to any shape of pipe, but because of its superior ability to restore hoop strength in cylindrical pipe, the method is especially useful with and is described in connection with repairing a tubular pipe.

### Reinforcing Layer

The support sleeve is not meant to carry a significant portion of the structural load of the pipeline (hoop stress or longitudinal stress). While the cementitious composition has high compressive strength, it has limited tensile strength. Accordingly, a reinforcing layer of fibrous material is used to reinforce the hardened cementitious composition by absorbing tensile stresses and loads that would otherwise crack or break the cementitious in the repaired area of the host pipe. Thus, the method provides a composite of a cementitious composition, such as a bleed-resistant grout composition, a support sleeve and a reinforcing layer of fibrous material that is bonded to the host pipe and has sufficient tensile, axial, compressive and hoop strength to stand alone as a new pipe within a pipe and increase the desired pressure rating of the pipe.

According to certain embodiments, the reinforcing layer of fibrous material comprises a bi-directional fabric. The fibers of the bi-directional reinforcing fabric comprise any fibers that may be used to prepare a fabric which can absorb tensile stresses and loads that would otherwise crack or break the cementitious in the repaired area of the host pipe. Without limitation, and only by way of illustration, suitable fibers that may be used to prepare the reinforcing fabric include aramid fibers, basalt fibers, carbon fibers, glass fibers, polymer fibers, such as polyester fibers, polyalkylene fibers (polypropylene fibers, polyethylene fibers, etc) or acrylic fibers, and combinations thereof.

According to certain embodiments, the fibrous material is configured to receive a cementitious material such as a grout to form a fiber-reinforced cementitious composite together with the support sleeve. For example, the fibrous material may have a weave structure to facilitate formation of a composite when the grout material is applied to the support sleeve in contact with the fibrous material. A wide variety of types of weaves and fiber orientations may be used in the fabric. For example, in certain embodiments, the fibers may be unidirectional, bidirectional, or omni-directional. With respect to omni-directional fabrics, a random configuration may also be utilized. A primary consideration in the choice of materials will be resistance to the components of the liquid carried in the pipe. Generally, the weave structure and other properties of the fiber may be specified to facilitate penetration of grout into the fiber structure.

Carbon fibers are useful fibers for their stiffness, strength and application properties, if the carbon fiber materials will be compatible with the underlying pipe. Many forms of carbon fiber may be used. An exemplary form of useful carbon fiber is MBrace® carbon fiber fabrics available from BASF Construction Chemicals.

In certain embodiments, the number of reinforcing layers depends on the desired pressure rating or desired maximum allowable operating pressure of the repaired piping system. According to certain embodiments, multiple reinforcing layers of fabric may be used to create a repaired pipe. The ultimate load the pipe may be subject to determines the thickness of the reinforcing layer, keeping in mind that excessive thickness unnecessarily reduces pipe capacity.

### Cementitious Composition

As described herein, a cementitious composition is infiltrated into the openings of the reinforcing fabric. According to certain embodiments, the cementitious composition that is infiltrated in the reinforcing fabric maybe selected from bleed resistant hydraulic pastes, bleed resistant grout, bleed resistant mortar, and bleed resistant concretes. The bleed resistant cementitious composition may comprise a bleed resistant grout.

While various bleed resistant grouts may be employed, in certain embodiments, the grout is a grout that is resistant to bleeding and manufactured by BASF Construction Chemicals under the product names Masterflow, 1205, Masterflow 1341, Masterflow 1515 PipeSaver, is a hydraulic cementitious grout composition comprising hydraulic cement, water and a copolymer, preferably polyacrylamide copolymers, as described in U.S. Pat. No. 7,044,170, incorporated herein by reference in its entirety. The grout is resistant to bleeding, has a sufficiently low viscosity to allow for pumpability and ease of placement, decreased volume change (plastic and hardened), extended working time, acceptable strength development, and provides corrosion protection for imbedded ferrous materials.

As set forth in U.S. Pat. No. 7,044,170, hydraulic cementitious compositions are materials that alone have hydraulic cementing properties, and set and harden in the presence of water. The hydraulic cementitious grout may include, but is not limited to, hydraulic cementitious grouts sold under the trademarks MASTERFLOW® (BASF Construction Chemicals, Shakopee, Minn., USA) SIKAGROUT® (Sika, Stockholm, Sweden), and CHEM-CRETE® (Chem Crete Corporation, Richardson, Tex.). In certain embodiments, the bleeding resistant additive added to the hydraulic cementitious grout mixture can be a copolymer of monomers such as N,N, dimethylacrylamide and 2-acrylamido, 2-methyl propane sulfonic acid, which can be present in an amount from about 0.001% to about 10.0% by weight based on the dry weight of the hydraulic cement. The typical water to cement ratio (W/C) of the reduced fluid loss hydraulic cementitious grout composition is no greater than about 0.45, preferably about 0.35 to about 0.44.

### Support Sleeve

The flexible, tubular support sleeve of polymeric material includes spacing elements formed on its outer surface facing towards and spaced apart from the interior of the host pipe. The spacing elements may comprise projections, flutes, ribs, spikes, seams and/or corrugations, which project axially and radially from the outer surface of the sleeve. The configuration, shape and size of the spacing elements may be engineered to meet performance requirements. When non-bleed grout is inserted in the annular cavity formed intermediate the host pipe's interior wall and the outer surface of the sleeve, the grout surrounds the spacing elements before setting and fills the voids between the spacing elements. The spacing elements are fully embedded in the grout resulting in a mechanical connection between the sleeve and the newly set grout, enhancing the structural strength of the newly formed pipe within a pipe that does not excessively restrict the inner diameter of pipe.

For purposes of illustration but not by way of limitation, the support sleeve comprises a high density polyethylene pipe liner.

Installation may be accomplished by various means known in the art, including pressurization, traveling mobile collapsible forms or carriers, or non-mobile framework that is constructed in place, all of which are brought into the pipe and removed from the pipe after the work is done through access points, such as manholes and hatches. The support sleeve is initially placed over a traveling, collapsible form movably positioned inside the pipe. When positioned, the form is expanded, pushing the sleeve into position. Next, the reinforcing layer is similarly positioned in contact with the inner surface of the support sleeve. Grout is inserted into the annular cavity between the support sleeve and the inside wall of the pipe and in the reinforcing layer. Alternatively, the support sleeve may be positioned inside the pipe by inserting a tube, sometimes inverted, of the support sleeve, and pressurizing the sleeve tube within the pipe to expand the sleeve to be in contact with the interior of the pipe. The reinforcing layer is similarly positioned in contact with the inner surface of the support sleeve.

It will be understood that to perform a complete installation, preparatory and finishing work must be performed. Typically, the pipe segment is inspected, cleaned and prepared and the flow of the medium normally carried by the pipe is diverted. Finishing operations include re-establishment of the lateral connections.

In certain embodiments, the generally cylindrical expander is mounted on a mandrel, and the support sleeve in folded or overlapped position is wrapped around the mandrel and expander. The mandrel and expander are inserted into the pipe with the spacing elements projecting from the outer surface of the support sleeve facing the inner surface of the host pipe, and moved to the location to be repaired. When the expander is positioned at the location to be repaired, the expander is expanded to push the support layer towards the inner surface of the host pipe. The expander is deflated and removed and the operation repeated for installation of the reinforcing layer into the support sleeve inside the pipe. The extendable expander is then extended to push the reinforcing layer and support sleeve radially outwardly towards the inner surface of the host pipe so that the reinforcing layer and sleeve expand (uncoil or unfold) into contact with the inner surface of the pipe. In certain embodiments, the expander comprises an inflatable bladder secured to a mandrel and the step of extending the expander comprises inflating the bladder with a pressurized fluid, such as air or a liquid. The expander functions both as a transport device to locate the support sleeve and the reinforcing layer at the appropriate spots in the pipe and as a packer to force the reinforcing layer and support sleeve towards the inside wall of the pipe being repaired, and hold it in position during the repair to allow the grout to set or harden.

A flowable, pumpable grout that is resistant to bleeding is inserted into the annular cavity between the support sleeve and the inner surface of the host pipe, at a first point along said pipe, so as to fill the annular cavity by flowing the grout in a generally longitudinal direction through the host pipe away from the first point towards a second point along the pipe, the spacing elements penetrating the grout as it flows in the annular cavity. The grout is pumped into the annular cavity so that it flows evenly down both sides of the support sleeve, permeating the sleeve and the reinforcing layer. The sleeve becomes mechanically adhered to the grout when the grout hardens, with the grout being placed inside the host pipe concurrent with the inflation of the sleeve/reinforcing layer. The spacing elements on the outer surface of the sleeve become embedded in the hardened grout. The grout contacts the inner surface of the host pipe uniformly and without interruption, forming a secure bond. The injected grout is allowed to set or harden sufficiently for the new pipe within a pipe to maintain its shape and be self-supporting. After hardening, the expander is deflated and withdrawn from the pipe.

The installation procedure described herein is a general description and it will be appreciated that the process can be designed to obtain desired results such as where over expansion, no expansion and/or smooth transitional shapes are required. It will be appreciated that field installation conditions vary.

While the method of repairing a host pipe having a defect has been described in connection with various illustrative embodiments, it will be understood that the embodiments described herein are merely exemplary, and that one skilled in the art may make variations and modifications without departing from the spirit and scope of the invention. All such variations and modifications are intended to be included within the scope of the claims herein. Further, all embodiments disclosed are not necessarily in the alternative, as various embodiments may be combined to provide the desired result. Therefore, the method of repairing a host pipe and repaired pipe should not be limited to any single embodiment, but rather construed in breadth and scope in accordance with the recitation of the appended claims.

1. A method of repairing a pipe having an inner diameter and a length comprising:
positioning a reinforcing fabric within at least a portion of the pipe; and
at least partially infiltrating the reinforcing fabric with a bleed resistant cementitious composition.

2. The method of claim 1, comprising spacing said reinforcing fabric apart from the inner surfaces of said pipe to form an annular cavity between said fabric and said pipe.

3. The method of claim 2, wherein said infiltrating said reinforcing fabric with said bleed resistant cementitious composition comprises infiltrating said composition into said fabric and into the annular cavity between said pipe and said fabric.

4. The method of claim 3, wherein said reinforcing fabric comprises one of a uni-directional fabric, a bi-directional fabric, or an omni-directional fabric.

5. The method of claim 4, wherein said bi-directional fabric comprises aramid fibers, basalt fibers, carbon fibers, glass fibers, polymer fibers, and combinations thereof.

6. The method of claim 5, wherein said wherein the bi-directional fibers comprise glass fibers.

7. The method of claim 6, wherein said bleed resistant cementitious composition is selected from the group consisting of bleed resistant hydraulic pastes, bleed resistant grouts, bleed resistant mortars, and bleed resistant concretes.

8. The method of claim 7, wherein said bleed resistant cementitious composition comprises a bleed resistant grout.

9. A method of repairing a pipe having an inner surface and a length comprising:
positioning a spacer layer adjacent the inner surface of said pipe forming an annular cavity between the inner surface of the pipe and the outer surface of the spacer layer;
positioning a reinforcing fabric on the inner surface of the spacer layer; and
at least partially infiltrating the reinforcing fabric and annular cavity with a cementitious composition.

10. The method of claim 9, wherein positioning the reinforcing fabric on the inner surface of the spacer layer comprises applying the reinforcing layer to contact the inner surface of the spacer layer.

11. The method of claim 10, wherein infiltrating the reinforcing fabric and annular cavity with a cementitious composition comprises pumping or gravity pouring a cementitious composition into the reinforcing fabric and into the annular cavity.

12. The method of claim 11, wherein infiltrating the reinforcing fabric and annular cavity with a cementitious composition comprises pumping.

13. The method of claim 12, further comprising allowing the cementitious composition to harden to form a mechanical bond between projections of the spacer layer and the pipe and between the spacer layer and the reinforcing fabric.

14. The method of claim 9, wherein positioning said spacer layer within said pipe comprises positioning a polymer sleeve within the interior of the pipe spaced apart from an inner surface of the pipe, the polymer sleeve having an inner surface and an outer surface, the outer surface of the polymer sleeve having a plurality of spacing elements projecting radially outwardly from the outer surface of the polymer sleeve.

15. The method of claim 14, wherein the sleeve comprises an external diameter such that an annular cavity is formed between the inner surface of the host pipe and the outer surface of the polymer sleeve.

16. The method of claim 9, wherein positioning a reinforcing fabric within the spacer layer comprises disposing a tubular reinforcing layer of fibrous material in contact with the inner surface of the spacer layer in the host pipe.

17. The method of claim 16, further comprising positioning an extendable expander inside of the tubular reinforcing layer and extending the expander to push the reinforcing layer and spacer layer radially outwardly towards the inner surface of the host pipe.

18. The method of claim 9, wherein infiltrating the reinforcing fabric and annular cavity with a cementitious composition comprises pumping or gravity pouring a cementitious composition into the reinforcing fabric and into the annular cavity.

19. The method of claim 18, wherein infiltrating the reinforcing fabric and annular cavity with a cementitious composition comprises pumping.

20. The method of claim 19, wherein pumping the cementitious composition into the annular cavity between the sleeve and the inner surface of the host pipe, at a first point along said pipe, so as to fill the annular cavity by flowing the cementitious composition in a generally longitudinal direction through the host pipe away from the first point towards a second point along the pipe, the spacing elements penetrating the composition as it flows in the annular cavity.

21. The method of claim 20, comprising permitting the cementitious composition to harden to form a composite of the reinforcing layer, the spacer layer, and the cementitious composition, the composite forming a pipe within a pipe, the spacing elements being embedded in the cementitious composition upon hardening of the cementitious composition.

22. The method of claim 9, further comprising terminating the pumping of cementitious composition into the annular cavity prior to allowing the cementitious composition to harden.

23. The method of claim 9, comprising maintaining the expander extended until the cementitious composition hardens sufficiently to be self-supporting and then retracting the expander.

24. The method of claim 23, wherein the expander is mounted on a mandrel, and the positioning step comprises wrapping the spacer layer around the mandrel and expander, then inserting the mandrel and expander into the pipe with the spacing elements projecting from the outer surface of the spacer layer facing the inner surface of the host pipe, and moving it to the location to be repaired.

25. The method of claim 9, wherein the expander is mounted on a mandrel, and the step of positioning the reinforcing fabric comprises wrapping the reinforcing layer around the mandrel and expander, then inserting the mandrel and expander into the spacer layer inside the pipe and moving it to the location to be repaired.

26. The method of claim 23, wherein the expander comprises an inflatable bladder and the step of extending the expander comprises inflating the bladder with a pressurized fluid.

27. The method of claim 9, wherein the spacer layer comprises a high density polyethylene.

28. A repaired pipe comprising:
a host pipe having an inner surface and a length; and
a cured composite material in adjacent contact with, or bonded to, said inner surface of said host pipe, wherein said composite material comprises a reinforcing fabric at least partially infiltrated with a bleed resistant cementitious composition.

29. The repaired pipe of claim 28 comprising:
a host pipe having an inner surface and a length;
a spacer layer adjacent the inner surface of said pipe; and
a cured composite material adjacent said inner surface of said spacer layer, wherein said composite material comprises a reinforcing fabric at least partially infiltrated with a bleed resistant cementitious composition.

30. The repaired pipe of claim 29 comprising:
a host pipe having an inner surface;
a spacer layer provided with spacing elements disposed on the inner surface of the pipe;
a bi-directional reinforcing fabric in adjacent contact with the inner surface of the spacer layer; and
a hardened cementitious composition forming a composite with the reinforcing fabric and spacer layer.

31. The repaired pipe of claim 30, wherein the hardened cementitious composition is in contact with the reinforcing fabric through the support sleeve.

32. A repair liner for lining a host pipe comprising:
a spacer layer having inner and an outer surfaces, wherein the outer surface of the spacer layer comprises spacing elements projecting radially outwardly from the outer surface of the layer; and
a reinforcing fabric layer in adjacent contact with the inner surface of the spacer layer.
